(19) United States
(12) Patent Application Publication
(10) Pub. No.: US 2008/0105609 A1
(43) Pub. Date: May 8, 2008

(54) Liquid Filter

(75) Inventor: James C. Keller, Lakeland, FL (US)

Correspondence Address: BABCOCK IP, PLLC, P.O.BOX 488, BRIDGMAN, MI, 49106, US

(73) Assignee: CONSERV MANUFACTURING, Lakeland, FL (US)

(21) Appl. No.: 11/936,888

(22) Filed: Nov. 8, 2007

Related U.S. Application Data
(60) Provisional application No. 60/864,817, filed on Nov. 8, 2006.

(51) Int. Cl. B01D 35/30

(52) U.S. Cl. 210/436

(57) ABSTRACT

A liquid filter, having a housing having an inlet port to an interior chamber with an upper opening. A cover coupled to the housing, covering the upper opening has at least one filter element coupled to the cover, the filter element(s) projecting into the interior chamber. The filter element(s) having an inner area enclosed between the filter element and the cover. A purge inlet through the cover and an outlet through the cover connect to the inner area.

### CROSS REFERENCE TO RELATED APPLICATIONS

This application claims the benefit of US Provisional Patent Application titled “SELF CLEANING LIQUID FILTER”, Ser. No. 60/864,817 filed Nov. 8, 2006 by Mr. James Keller.

### BACKGROUND

1. Field of the Invention

The present invention generally relates to liquid filters and or strainers. More specifically, the present invention relates to a cost efficient liquid filter usable in a reduced cycle time self cleaning liquid filter system.

2. Description of Related Art

Liquid filters are used in a wide range of processes to remove contaminants from liquids. An example of a self cleaning liquid filter and related process system for waste water recovery in a car wash is disclosed in U.S. patent application Ser. No. 11/060,112 filed Feb. 8, 2005, titled “Waste Water Recovery System” also invented by the inventor of the present application, Mr. James Keller. The application is co-owned with the present application by GKWF, Inc. and is hereby incorporated by reference in the entirety.

The waste water recovery systems of commercial car washes are required to filter large volumes of water on a continuous basis. As the filter periodically becomes clogged with contaminants filtered from the process stream, a cleaning cycle including a reverse direction air and liquid purge is applied. To allow continuous operation of the waste water recovery system, a parallel filter assembly is supplied. While one filter is performing a cleaning cycle, the process stream is routed through the other filter by as series of automated flow control valves. The parallel filter arrangement, piping, valves and associated automation controls significantly increases both the cost and space requirements of the resulting system.

Prior self cleaning filters, for example as shown in FIG. 1, have a filter element 10 suspended within a, for example, cylindrical housing 12 from a collar 14 that seats against an inward projecting shoulder 16 of the housing 12 sidewall 18. In a filtering mode, process liquid flows from an inlet process line 20 into an inlet port 22 at the bottom of the housing 12, through the filter element 10 and out a sidewall 18 outlet port 24 proximate the top of the housing 12 to an outlet process line 26. The filter element 10 collar 14 is retained against the shoulder 16 by a spider arrangement 28 that extends from the collar 14 upward to contact a removable access cover 30 that seals the housing 12. A sealing gasket 32 seals between the collar 14 and the shoulder 16, preventing process flow from bypassing the filter element 10.

During a periodic back wash step, the inlet process line 20 is closed and a drain connection 36 of the inlet process line 20 opened to create a path from the housing 12 to drain. The outlet process line 26 is closed and a pressurized, for example air, purge is applied through a purge inlet 38 in the cover 30 to drive the process fluid filling the housing 12 in a reverse direction through the filter element 10 to the drain connection 36, dislodging and flushing away any contaminants that have been captured against the outer surface 40 of the filter element 10. After the back wash step has completed, an air purge step begins. In the air purge step, the purge inlet 38 is closed, an exhaust connection 44 in the cover 30 is opened, the drain connection 36 to the inlet process line 20 closed and the process flow reintroduced into the inlet process line 20 and housing 12, pushing out the air through the exhaust connection 44 until the housing 12 is once again filled with process fluid, whereupon the exhaust connection 44 is closed and the outlet process line 26 opened to place the system back into filtering mode.

Competition within the filter housing industry has focused attention upon minimization of materials and manufacturing costs. Also, size requirements of the filter housing and or surrounding process equipment are significant factors for commercial success.

Therefore, it is an object of the present invention to provide an apparatus that overcomes deficiencies in the prior art.

### BRIEF DESCRIPTION OF THE FIGURES

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a partial cut-away side view of a prior art liquid filter assembly.

FIG. 2 is a partial cut-away side view of an exemplary embodiment of a liquid filter assembly according to the invention.

FIG. 3 is a partial cut-away side view of a multiple filter element embodiment of a liquid filter assembly according to the invention.

### DETAILED DESCRIPTION

The inventor has recognized problems with the prior filter design. Specifically, the materials and manufacturing costs related to forming the close tolerance shoulder 16, corresponding filter element 12 collar 14 and the spider arrangement 28. Also, the sealing gasket 32 between the shoulder 16 and the collar 14 creates a failure point that can allow unfiltered process liquid to bypass the filter element 10 to damage and or contaminate downstream equipment if the sealing gasket 32 degrades over time and or fails to be properly installed during periodic inspection/manual cleaning of the housing 12. A purge line 46 coupled to the purge inlet 38 typically does not extend deeply within the filter element 10 because the purge line 46 is relatively fragile and may either itself be damaged or cause damage to the filter element 10 unless the cover 30 it is attached to is removed and reseated with great care.

Further, the inventor has recognized that the prior parallel dual filter systems that enabled continuous operation by providing an alternate filtering path while one of the parallel filter assemblies is in a self cleaning mode may be eliminated and replaced by a single filter assembly and a buffer tank, greatly reducing the overall system cost and complexity. A significant drawback of a buffer tank filter system configuration is the size of the buffer tank required to provide continuous operation while the filter is backwashed. The size of the buffer tank required is proportional to the desired system flow rate and the time required for the backwash cycle.

According to the present invention, the time required for the backwash cycle may be minimized without impacting the period between cycles by reducing the volume of the filter assembly not dedicated to filter surface area, thereby resulting in faster backflush and air purge step times.

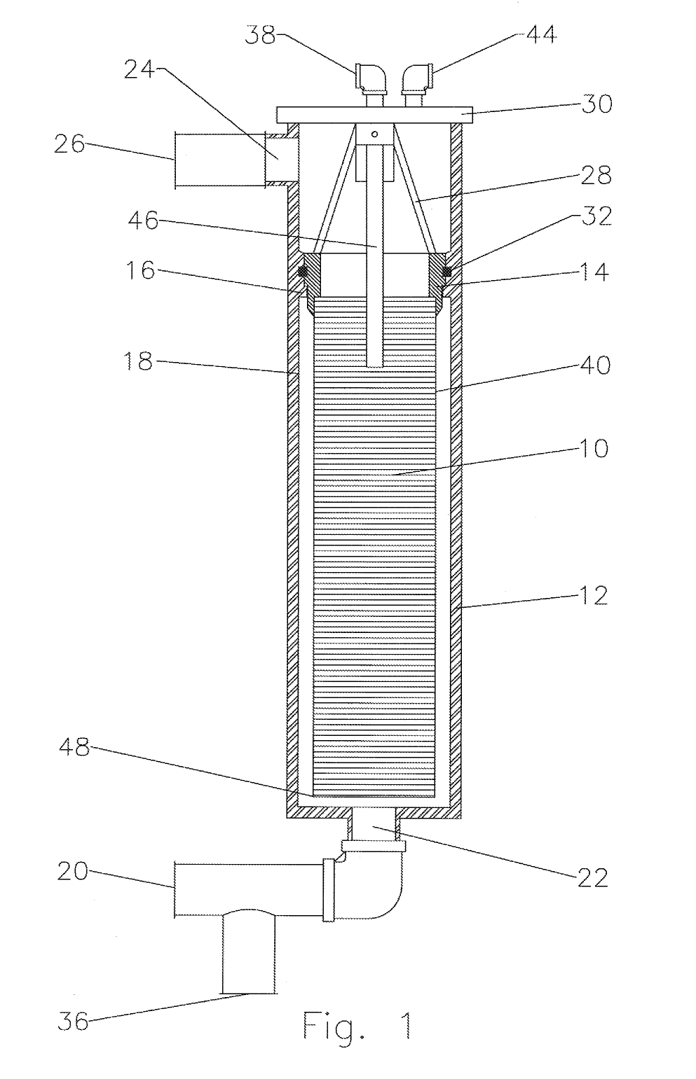

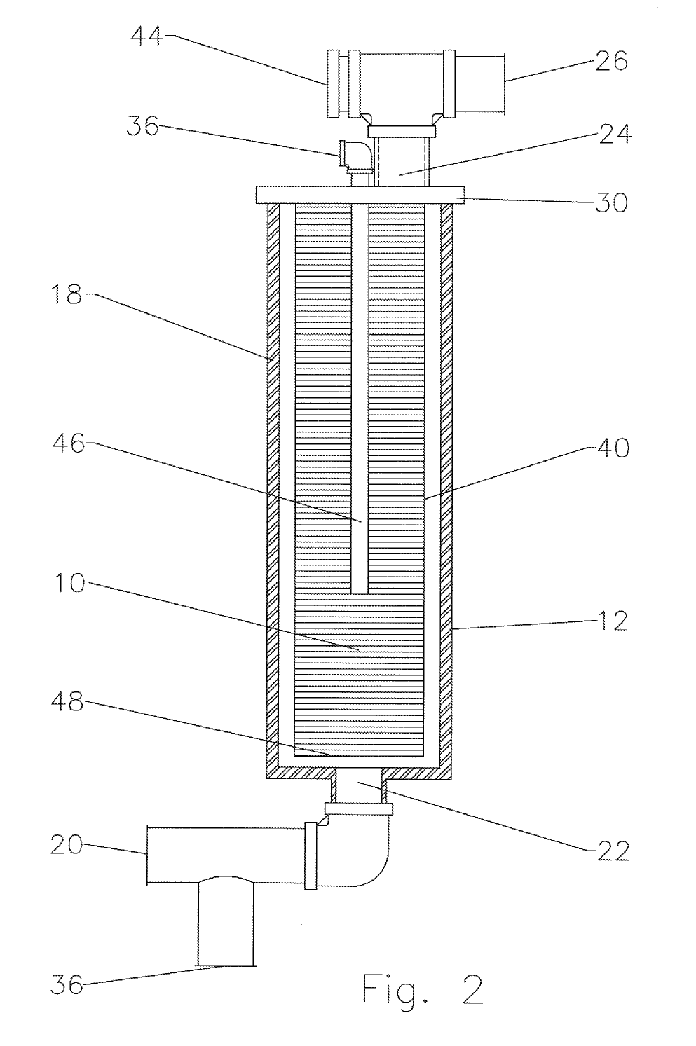

As shown for example in FIG. 2, common elements from FIG. 1 similarly notated, a filter assembly according to the invention may be formed by locating the outlet port 24 on the cover 30 at a location within the area of the filtered side of the filter element 10 which is also coupled to the cover 30 instead of a sidewall 18 mounted shoulder. The cover 30 is dimensioned to seal an upper opening 50 of the housing 12. This arrangement allows the filter housing 12 and corresponding interior chamber 52 to be significantly shorter, eliminating the prior space between the collar 14 of the filter element 10 and the cover 30, where the outlet port 24 was attached to the housing 12 sidewall 18, as shown in FIG. 1. Thereby, the volume of the assembly not dedicated to filter surface area is minimized. As a result, applied to a similar waste water recovery system, a backwash cycle time of the prior liquid filter that previously required approximately 9 seconds is reduced to approximately 6 seconds. The air purge cycle time is similarly shortened. These time savings significantly reduce the system buffer volume required in a single filter assembly and buffer tank filtering system, increasing the cost efficiency of these systems, compared to prior parallel filter or single filter with larger buffer tank continuous filtration arrangements.

Coupling the filter element 10, for example a wedge wire basket, directly to the cover 30, also introduces significant materials and manufacturing cost savings by eliminating the material, component manufacturing and assembly steps required to form and install the prior filter element 12, collar 14, shoulder 16 and spider arrangement 28.

A filter element 10, for example a wedge wire basket, may be formed by mounting a generally triangular cross section wire with the triangle base along the perimeter of the basket and the triangle point facing inward to the filter element 10 interior. Adjacent wedge wires are mounted spaced apart by the desired filter gap. Thereby, the gap separated adjacent wedge wire triangle bases present a generally planar surface to the unfiltered side and a sloping open surface to the filtered side. The generally planar surface aids in collection/deposition of filtrate on the unfiltered side while the sloping open surface of the filtered side minimizes the opportunity for any disposition and or fouling on the filtered side, which improves the filter element cleanability via backflushing.

The cover 30 and filter element 10 may be removably attached to one another, for example via fasteners between the cover 30 and a flange of the filter element 12, sealed with a seal gasket 32. However, by permanently attaching the filter element 10 directly to the cover 30 as shown in FIG. 2, for example by metal-to-metal or ultrasonic polymer/plastic welding, manufacturing costs are reduced and the failure point associated with the prior seal gasket 32 may be eliminated. Similarly, the purge line may be provided with a permanent connection to the purge inlet 38 on the cover 30.

The unfiltered inlet area of the housing where any fouling of the filter element 10 outer surface 40 not removed by the self cleaning cycle(s) is most likely to remain is still readily accessible by removing the cover 30 to access the outer surface 40 of the attached filter element 12. In special circumstances, the filtered side of the filter element 10 may be accessed through the outlet port 24 and or any uncleanable matter dissolved via dipping of the cover/filter element assembly into a suitable corrosive and or caustic bath.

A further improvement over the prior self cleaning filters is achieved by extending the length of the air purge line 46 from the cover 30 towards the bottom of the filter element 12, for example to between 50 and 90 percent of the distance from the cover to the bottom 48 of the filter element 10. This applies maximum air pressure at the bottom area of the filter element 10, the area that experiences the worst fouling during operation due to its proximity to the inlet port 22. Because the extended air purge line 46 is permanently surrounded by the filter element 10 when the cover 30 is removed, the danger of damaging the air purge line 46 and or damaging the filter element 12 by inadvertently hitting it with the air purge line 46 during servicing has been eliminated.

To equalize flow as much as possible through the liquid filter, the housing 12, filter element 10 and purge line 46 may each be applied with cylindrical outer dimensions oriented coaxial with one another. Further, locating the inlet port at a center of the housing bottom also aids in equalizing the flow distribution.

The filter housing is demonstrated in FIG. 2 with process piping connections directly to the various ports. These connections may also be provided with quick release features to simplify maintenance, inspection and or any required manual cleaning.

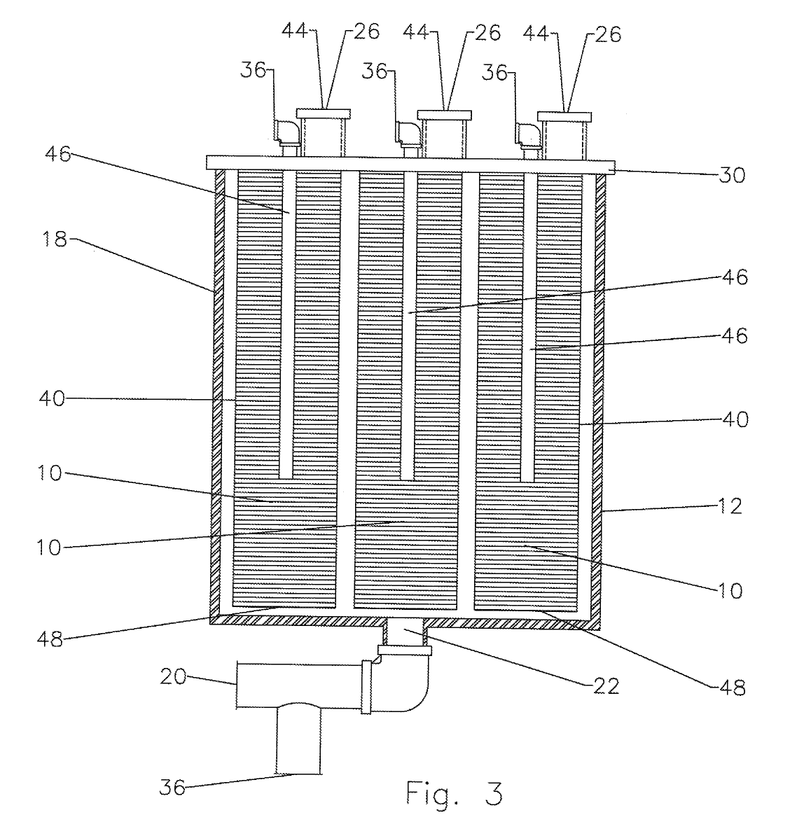

In further embodiments, for example as shown in FIG. 3, to increase the potential filter element 10 surface area, and or provide filtered process liquid simultaneously to multiple independent process fluid consumers, multiple filter element(s) 10 may be applied to a common cover 30. The outlet process connection 26 and purge line connection 44 of each filter element 10 may be ganged together or directed to independent process fluid consumers as desired. Where isolation valves are applied to the outlet process connection 26 and purge line connection 44 of each filter element 10, the process controls may be arranged to backwash an individual filter element 10, on demand.

One skilled in the art will appreciate that the present invention represents a significant cost savings with respect to required materials, components, manufacturing and servicing. Further, the present invention reduces the level of complexity, automation and system footprint when incorporated into a system that replaces the prior parallel dual filter arrangement with a single filter according to the invention and a buffer tank. Compared to prior single filter/buffer tank systems, the present invention enables use of a buffer tank with smaller size and associated cost requirements than possible with systems utilizing a conventional filter housing.

Table of Parts

| | |
|---|---|
| 10 | filter element |
| 12 | housing |
| 14 | collar |
| 16 | shoulder |
| 18 | sidewall |
| 20 | inlet process line |
| 22 | inlet port |
| 24 | outlet port |
| 26 | outlet process line |
| 28 | spider arrangement |
| 30 | cover |
| 32 | sealing gasket |
| 36 | drain connection |
| 38 | purge inlet |
| 40 | outer surface |
| 44 | exhaust connection |
| 46 | purge line |
| 48 | bottom |
| 50 | upper opening |
| 52 | interior chamber |

Where in the foregoing description reference has been made to ratios, integers, materials, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A liquid filter, comprising:
a housing having an inlet port to an interior chamber with an upper opening;
a cover coupled to the housing, covering the upper opening;
a filter element coupled to the cover, the filter element projecting into the interior chamber; the filter element having an inner area enclosed between the filter element and the cover;
a purge inlet through the cover into the inner area; and
an outlet through the cover into the inner area.

2. The liquid filter of claim 1, wherein the filter element is wedge wire spaced apart by a gap.

3. The liquid filter of claim 1, wherein the filter element is permanently attached to the cover.

4. The liquid filter of claim 1, wherein the purge inlet has a purge line extending into the inner area.

5. The liquid filter of claim 4, wherein the purge line extends into the inner area between 50 and 90 percent of a distance between the cover and a bottom of the filter element.

6. The liquid filter of claim 4, wherein the purge line is permanently attached to the cover.

7. The liquid filter of claim 4, wherein the purge line and filter element are cylindrical and are oriented coaxial with respect to each other.

8. The liquid filter of claim 1, wherein the housing and filter element are cylindrical and are oriented coaxial with respect to each other.

9. The liquid filter of claim 1, wherein the inlet port is centered in a bottom of the housing.

10. The liquid filter of claim 1, wherein there are multiple filter elements.

11. A liquid filter, comprising:
a housing having an inlet port to an interior chamber with an upper opening;
a cover coupled to the housing, covering the upper opening;
a wedge wire filter element permanently attached to the cover, the filter element projecting into the interior chamber; the filter element having an inner area enclosed between the filter element and the cover;
a purge inlet through the cover has a purge line permanently attached to the cover that extends into the inner area;
the purge line extending into the inner area between 50 and 90 percent of a distance between the cover and a bottom of the filter element; and
an outlet through the cover into the inner area.

12. The liquid filter of claim 11, wherein the housing, purge line and filter element are cylindrical and are each oriented coaxial with one another.

13. The liquid filter of claim 11, wherein the inlet port is centered in a bottom of the housing.

14. A liquid filter, comprising:
a housing having an inlet port to an interior chamber with an upper opening;
a cover coupled to the housing, covering the upper opening;
a plurality of filter element(s) coupled to the cover, each of the filter element(s) projecting into the interior chamber; the filter element(s) each having an inner area enclosed between each of the filter element(s) and the cover;
a purge inlet through the cover into each of the inner area(s); and
an outlet through the cover into each of the inner area(s).

15. The liquid filter of claim 14, wherein each of the plurality of filter element(s) are positioned equidistant from one another.

16. The liquid filter of claim 14, wherein each of the plurality of filter element(s) are cylindrical.
